(19) United States
(12) Patent Application Publication
(10) Pub. No.: US 2014/0061522 A1
(43) Pub. Date: Mar. 6, 2014

(54) Valve Actuator with Degressive Characteristic Spring

(71) Applicants: Mihirkumar Pravinbhai Patel, Bangalore (IN); David D. Comeaux, Houston, TX (US); Michael J. Denk, Houston, TX (US); Chau Hoang, Houston, TX (US)

(72) Inventors: Mihirkumar Pravinbhai Patel, Bangalore (IN); David D. Comeaux, Houston, TX (US); Michael J. Denk, Houston, TX (US); Chau Hoang, Houston, TX (US)

(73) Assignee: VETCO GRAY INC., Houston, TX (US)

(21) Appl. No.: 13/603,951

(22) Filed: Sep. 5, 2012

(51) Int. Cl. F16K 25/00

(52) U.S. Cl. 251/193

(57) ABSTRACT

An actuator for a gate valve having a gate has a stem coupled to a gate. A spring is coupled to the stem and has an extended length position while the gate is in a closed position and a contracted length position while the gate is in an open position. The spring has a degressive characteristic such that a graph of a force required to move the gate from the closed position to the open position versus a deflection of the spring is a nonlinear curve with a positive slope that decreases when moving from the closed to the open position. The spring may be an array of wavy springs arranged in nested and in valley-to-crest combinations.

### FIELD OF DISCLOSURE

This disclosure relates in general to subsea gate valve actuators, and in particular to an actuator with a fail-safe spring that has a degressive curve characteristic.

### BACKGROUND

Gate valves are often employed. in subsea hydrocarbon production facilities. A gate valve has a stem that is moved by a power source to stroke the gate. Normally, power must continually be applied to hold the gate in the open position for subsea use. The power source may be hydraulic or electric. A spring may be used to move the gate from the open position back to the closed position in the event of failure of the power.

In some uses, the gate valve must be capable of shearing a line extending through the flow passage. Lines are employed to lower tools and instruments into the wellbore. If an emergency occurs that requires closure of the gate while the tool is still in the wellbore, the spring must be capable of applying enough force to shear the line independently of the power source.

Prior art subsea gate valves normally have constant diameter helical coil springs. The force required to move the coil spring from the extended position, where the gate is closed, to the contracted position normally increases throughout the travel of the gate. A considerable length of travel of the gate occurs from the point where the line would be sheared to the fully open position. Consequently, after shearing, the power source has to be able to exert considerably more force to move the gate from the point Where the line would shear to the open position. Also, the force has to be maintained for long periods of time because the valves are normally kept in the open position.

### SUMMARY

An actuator for a gate valve has a stem adapted to be coupled to a gate. Axial movement of the stem from a first position to a second position strokes the gate from a first position to a second position. A spring having a fixed end and a movable end, the movable end being mounted to the stem for axial movement therewith. The spring has an extended length position while the stem is in the first position and a contracted length position while the stem is in the second position. The spring has a degressive characteristic such that a graph of a force required to move the stem from the first position to the second position versus a deflection of the spring while moving from the first position to the second position is a nonlinear curve with a positive slope that decreases when moving from the first to the second position.

Preferably, a force required to maintain the stem halfway between the first position and the second position is more than one-half a force required to maintain the stem in the second position. In the preferred embodiments, a slope of the nonlinear curve at any point between the first position and a halfway point halfway to the second position is greater than the slope of the nonlinear curve at any point from the halfway point to the second position.

The spring may be an array of circular wavy springs stacked on each other, each of the wavy springs being split and having undulations defining crests and valleys. Selected ones of the wavy springs may be mounted with the valleys of one of the wavy springs nesting in the valleys of an adjacent one of the wavy springs. Selected adjacent ones of the wavy springs may be mounted with the valleys of one of the wavy springs abutting the crests of an adjacent one of the wavy springs.

The spring may be an array of Belleville springs. Selected adjacent ones of the Belleville springs may he nested within one another. Selected adjacent ones of the Belleville springs may he mounted opposed to each other.

The spring may be a coil spring array with a varying outer diameter between the ends. Al least a portion of the coil spring array may he barrel shaped, having a progressively increasing diameter from one of the ends to a central section and a decreasing diameter from the central section toward the other of the ends. At least a portion of the coil spring array may he in the shape of an hourglass, having a diameter that progressively decreases from one of the ends to a central section and an increasing diameter from the central section toward, the other of the ends.

### BRIEF DESCRIPTION OF THE DRAWINGS

FIG. 1 is a simplified cross-sectional view of a gate valve and actuator constructed in accordance with this disclosure.

FIG. 2 is a partial cross-sectional view of the gate valve of FIG. 1, shown in the process of shearing a line.

FIG. 3 is a curve of the force required to move the gate of the gate valve of FIG. 1 from a closed position to an open position.

FIG. 4 is a perspective view of a nested array of wavy springs suitable for use in a spring of the actuator of FIG. 1.

FIG. 5 is a side view of a spring array that includes several of the nested arrays of FIG. 4 in a crest-to-valley arrangement with each other.

FIG. 6 is a perspective view of a spring array that includes several nested arrays similar to FIG. 4 in crest-to-valley arrangements with each other.

FIG. 7 is a graph of force versus deflection for several arrays of Belleville springs.

FIG. 8 is a side view of two barrel-shaped, coil spring portions on top of each other.

FIG. 9 is a side view of two hourglass-shaped coil spring portions on top of each other.

### DETAILED DESCRIPTION

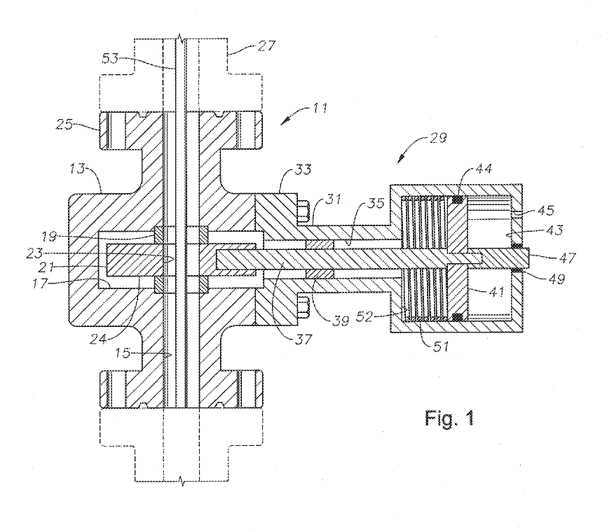

Referring to FIG. 1, an example of a gate valve 11 is illustrated. Gate vale 11 has a body 13 with an axial flow passage 15. Body 13 may have a variety of shapes. A cavity 17 is perpendicular to and intersects flow passage 15. Seat rings 19, which may be considered to be part of body 13, are typically located at the junctions of cavity 17 with flow passage 19. A gate 21 moves through cavity 17 perpendicular to flow passage 15. Gate 21 has a hole 23 therethrough that registers with flow passage 15 while in the open position shown in FIG. 1. Gate 21 has a solid sealing portion 24 adjacent hole 23 that seals against the downstream seat ring 19 while in the closed position. Body 13 connects into other wellhead structure, which may within a subsea tree or other types of equipment. In this example, body 13 has flanges 25 that bolt to conduits 27, shown by dotted lines, which may represent portions of subsea equipment.

An actuator 29 bolts to body 23 and extends perpendicular to flow passage 15. Actuator 29 is illustrated as a hydraulic type, but it could be electrically powered. Actuator 29 has a housing 31, which may comprise multiple components, and a flange 33 that is bolted to body 23. Housing 31 has a stem cavity 35 extending laterally from body 23 in alignment with gate cavity 17. A stem 37 has an inner end that couples to gate 21 and extends outward within stem cavity 35. Seals 39 seal around stem 37 to seal pressure in gate cavity 17 from the portion of stem cavity 35 outward from seals 39. An outer portion of stem 37 rigidly connects to a piston 41, so that movement of piston 41 moves stem 37 in unison. Piston 41 is located in a chamber 43 in housing 31 and has a seal 44 that seals against the inner wall of chamber 43. One or more ports 45 supply and relieve hydraulic fluid pressure from chamber 43. In this example, hydraulic fluid pressure acts only on the outer side of piston 41 to open gate 11. Piston 41 is not supplied with hydraulic fluid pressure to move gate 11 to the closed position in this example. Stem 37 may have an. extension 47 that extends from piston 41 through chamber 43 and out a sealed hole 49 in the outer end of housing 31. Hydrostatic pressure of sea water will act against stem extension 47, exerting an inward force.

A spring 51 is located within housing 31 on the opposite side of piston 41 from chamber 43. Spring 51 has an inner end that abuts a shoulder 52 in housing 31 and may be considered fixed as the inner end does not move with piston 41 and stem 37. The outer end of spring 51 is arranged to move in unison with piston 41 and stern 37. The outer end may abut piston 41 or a retainer (not shown) secured to stem 37. While gate 11 is in the open position, hydraulic fluid pressure in chamber 43 maintains spring 51 in a contracted position. If the hydraulic fluid pressure is relieved or fails, spring 51 has adequate force to push piston 41, stem 37 and gate 21 to a closed position.

Gate valve 11 may be utilized with subsea equipment wherein a line 53 passes through flow passage 53, typically to lower an instrument or other downhole tool into the well. Line 53 may be a cable with or without electrical conductors, or it may comprise coiled metal tubing. During an emergency, gate 21 must have the ability to fully close quickly even if there is not enough time to retrieve the downhole device and line 53. Gate 21 has a least one edge portion in hole 23 that will shear line 53 based entirely on the force of spring 51 pushing gate 21 to the closed position. The shearing edge portions in hole 23 are not illustrated, but they may be sharp and configured for shearing action.

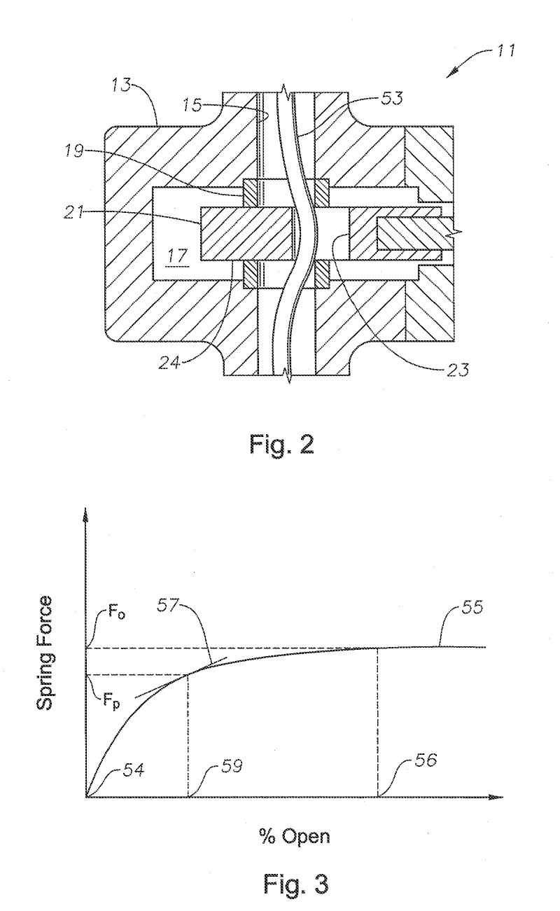

As shown in FIG. 2, when gate 21 begins moving toward the closed position with line 53 still in flow passage 15, gate 21 will push line 53 laterally over to a pinch point where line 53 is trapped between edges of hole 23 and seat rings 19. The force exerted by spring 51 at the pinch point is sufficient to sever line 53. The pinch point varies depending on the diameter of line 53. The force required of spring 51 at the pinch point depends on the type of line 53 plus other factors. One factor would be the pressure that may be in flow passage 15 during the emergency closure. That flow passage pressure force would exert an outward force on stern 37 assisting spring 51 in closing gate 21 due to the difference in the pressure area of gate 21 and stem 37. Friction forces and hydrostatic pressure acting on stem extension 47 oppose the closing force caused by spring 51 and pressure in flow passage 15. Also, as the gate nears closure, such as 80 to 90% closed, which may be a pinch point, the pressure in cavity 35 on the inner side of seal 39 drops significantly below the pressure in flow passage 15, This reduction in pressure in cavity 35 on the inner side of seal 39 reduces the force required of spring 51 to complete closure of gate 21 and occurs whether or not a line 53 is being sheared. Spring 51 thus does not need to exert as much force to complete closure once it has reached a selected closure point than at other places of gate 21 during closure.

The work required to open gate 21 from a closed to an open position depends on the force required to move spring from its extended position to its contracted position. Hydrostatic pressure acting on stem extension 47 assists the force exerted by piston 41. The hydraulic pressure in chamber 43 must be maintained while gate 21 is open, which could be a lengthy period of time. A very stiff spring 51 may have the ability to easily close gate 21 and shear line 53 regardless of the hydrostatic pressure. However, a very stiff spring 51 requires considerable energy to open and maintain gate 21 open.

FIG. 3 illustrates a curve 55 of spring 51 (FIG. 1) representing the spring force required to move spring from an extended position to a contracted position. Fully closed position 54 occurs when gate 21 (FIG. 1) is completely closed, and is graphically illustrated as zero, although spring 51 could still be slightly contracted While gate 21 is fully closed. Spring 51 may be extended to substantially its full extent while in closed position 54. A fully open position 61 for gate 21 represents when spring 51 is substantially fully contracted. Curve 55 is nonlinear between closed position 54 and open position 56. A tangent line or slope 57 to curve 55 is positive and steepest at closed position 54. Slope 57 is always positive from closed position 54 to open position 56 in that the force is always increasing when moving gate 21 from the open to the closed position. Although. always positive, slope 57 continually decreases from closed position 54, becoming less positive until it substantially reaches open position 56, where slope 57 is substantially level.

A pinch point 59 is chosen to represent the force Fp required to maintain spring 51 at a selected point along its travel, such as wherein line 53 (FIG. 2) becomes trapped, The force Fp is equal to the amount of force spring 51 can exert at pinch point 59. The force Fp at pinch point 59 must be adequate to shear line 53 (FIG. 2) if gate valve 11 is to be a shearing type. If not a shearing type, pinch point 59 may represent the force when gate 21 is a selected distance from full closure, such as 80-90%. The force Fo indicates the amount of force required of piston 41 (FIG. 1) to maintain gate 21 in the fully open position 56. Note that the slope 57 of curve 55 becomes increasingly less positive from pinch point 59 to open position 56. The difference between pinch point force Fp and fully open force Fo is far less than the difference between pinch point force Fp and the force required to initially move gate 21 from the closed position 54. For example, pinch point force Fp may be 70 to 90% of the fully open force Fo.

The distance that gate 21 moves from fully closed position 54 to pinch point 59 may be less than the distance gate 21 moves from pinch point 59 to fully closed position 56. Typically, the distance from fully closed position 54 to pinch point 59 is less than one half the total distance from fully closed position 54 to fully open position 56. In the example shown, pinch point 59 is shown as about 30% the total distance from fully closed position 56 to fully open position 54, but that distance can vary considerably. A distance ratio may be considered to be the distance from fully closed position 54 to pinch point 59 divided by the total distance from fully closed position 54 to fully open position 56. In this example, the distance ratio is 0.30.

A force ratio may be considered to be the force Fp required to hold gate 11 in the pinch point position 59 divided by the force Fo to hold gate 11 in the fully open position 56. In this example, the force ratio is about 80%. Preferably, the force ratio is always greater than the distance ratio, regardless of where pinch point 59 is located. Consequently, the work required to move gate 21 from the fully closed position to the pinch point position 59 is always less than the work required to move gate 21 from the pinch point position 59 to the fully open position 56.

As another example, if pinch point 59 happens to be halfway between closed position 54 and open position 56, the force to maintain gate 21 at the hallway point would be more than one-half the force required to move gate 21 from the halfway point to the closed position. In that example, curve 55 shows the force Fp to be about 85% of the force Fo.

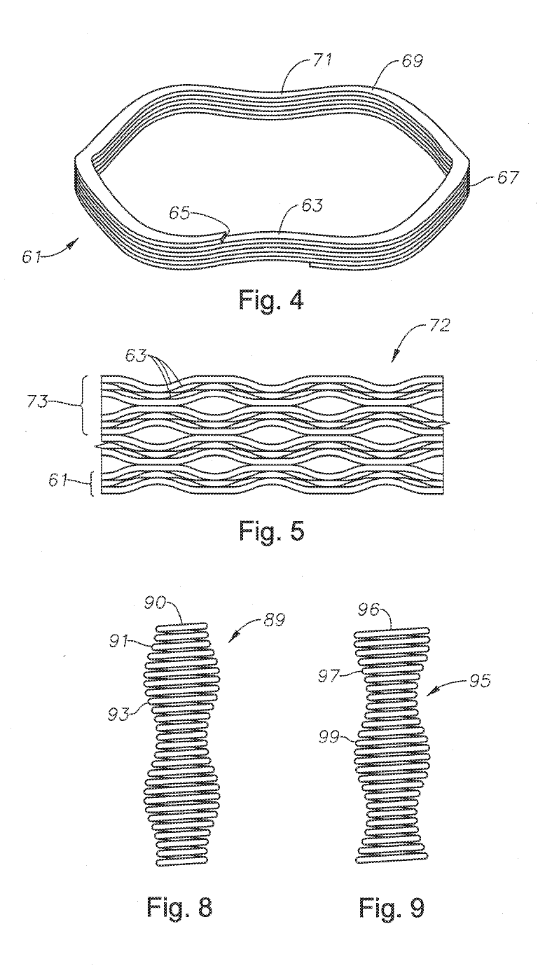

The ability of spring 51 to deflect according to curve 55 may be referred to a degressive characteristic. Springs can be configured to provide a desired degressive characteristic for a given gate valve application. Referring to FIG. 4, a single nested array 61 of wavy springs 63 is shown. Each wavy spring 63 in nested array 61 is a generally circular strip of metal that is split with two ends 65, 67 separated from each other. Each wavy spring 63 undulates, having crests 69 and valleys 71. A transverse cross-section through wavy spring 63 would appear rectangular. Typically, the crests 69 and valleys 71 are identical in pitch and amplitude, similar to a sinusoidal waveform. If wavy spring 63 is inverted, the crests 69 appear as valleys 71. When nested as shown in FIG. 4, valleys 71 rest on one another and crests 69 are on top of each other. The number of wavy springs 63 stacked on each other can vary and will change the force versus deflection curve.

In FIG. 5, an array 72 is illustrated that has four nested sets 61 of wavy springs 63, each nested set 61 shown as having four wavy springs 63, but the number can vary. Each nested set 61 is positioned relative to an adjacent nested set 61 in a valley-to-crest arrangement 73. That is, valleys 71 of the lowest wavy spring 63 in the uppermost nested set 61 contact crests 69 on the top wavy spring 63 of the next lower nested set 61. The number of wavy springs 63 in each nested set 61 can vary within array 72, with some having more wavy springs 63 that the others.

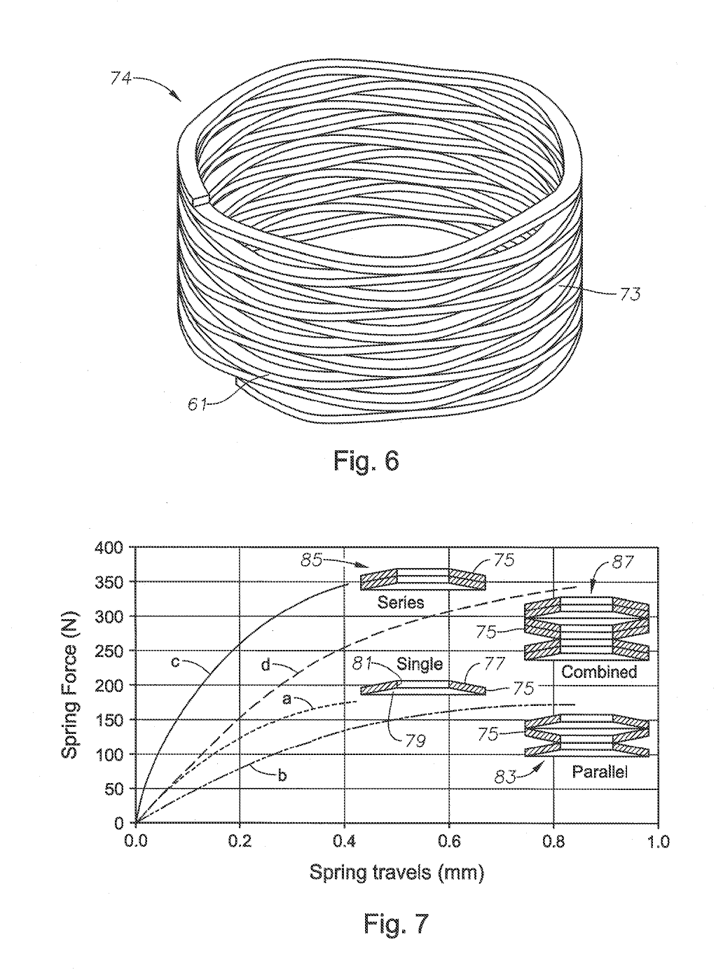

FIG. 6 illustrates an array 74 similar to FIG. 5, but having more nested sets 61 and more valley-to-crest arrangements 73. Each nested set 61 has only two wavy springs 63, rather than four as in FIG. 5. Various combination of nested wavy sets 61 and valley-to-crest arrangements 73 will achieve a desired degressive characteristic curve 55.

FIG. 7 illustrates various arrays of Belleville springs 75 superimposed on a graph of force versus deflection of the various arrays. Each Belleville spring 75 is a conical metal washer having an exterior side 77, an interior side 79 and a central hole 81. Curve a illustrates the characteristics of a single Belleville spring 75 of a selected dimension undergoing deflection. The force increases in a non linear manner, but the amount of deflection to the fully collapsed position is likely not adequate for use as a single Belleville spring 75 in a gate valve actuator.

Curve b shows a parallel array 83 of three Belleville springs 75 stacked inverted or opposed relative to each other. Curve b shows that the deflection is much greater than single Belleville spring 75, but the deflection force is less, thus likely not high enough to be utilized in a subsea gate valve actuator.

Curve c shows a series array 85 of two Belleville springs 85 nested with each other in a series arrangement. The force to deflect fully is higher than single Belleville spring 75 and higher than the parallel array 83. However, the deflection may not be large enough for use in a subsea gate valve actuator.

Curve d illustrates a combined array 87 of three sets of nested or series arrangements 85, with each arrangement 85 being opposed or parallel to the adjacent arrangement 85. Combined array 87 produces a force versus deflection curve that is degressive, that has as much deflection as the parallel arrangement of curve b, and requires no more force that the series arrangement of curve c. The combined array 87 may be suitable for use in certain gate valve actuators.

FIG. 8 illustrates an array 89 of two barrel-shaped coil spring portions stacked top of each other. Each barrel-shaped coil spring portion has an increasing diameter portion 91 that increases in diameter from. one end 90 to a maximum diameter central portion. A decreasing diameter portion 93 extends downward from the central portion toward the other barrel-shaped coil spring portion. A single barrel-shaped coil spring produces a progressive spring characteristic, rather than. degressive. That is the slope of the curve continually increases from the undeflected state toward the contracted state, opposite to a degressive curve. However, when combined as the array 89, the curve becomes degressive.

FIG. 9 illustrates another spring array 95 suitable for providing a degressive curve. Array 97 illustrates two hourglass-shaped coil spring portions. A decreasing diameter portion 97 extends from one end 96 to a minimum diameter central portion. An increasing diameter portion 99 extends downward from the central portion to the next hourglass-shaped spring portion. Other types of springs may be arranged to provide a desired degressive characteristic curve for a gate valve actuator.

The use of a degressive fail-safe spring for a gate valve actuator results in less energy required to maintain the gate in the open position than prior art springs of helical, cylindrical design. Rather than the force required to deflect the spring increasing significantly throughout the entire travel distance, with a degressive spring, little additional force is required to contract the spring from a selected pinch point to full contraction.

While only a few embodiments are described, it should be apparent to those skilled in the art that it is not limited to such embodiments, but is subject to variations. For example, in some cases, the actuator may be arrange to have a fail-safe open position rather than a fail-safe closed position. In such an instance, the spring is required to move the gate from a closed position to an open position.

1. An actuator for a gate valve having a gate, the actuator comprising:
a stern having an axis;
the stern adapted to be coupled to a gate, such that axial movement of the stern from a first position to a second position strokes the gate from a first position to a second position;
a spring having a fixed end and a movable end, the movable end being mounted to the stem for axial movement therewith, the spring having an extended length position while the stem is in the first position and a contracted length position while the stern is in the second position; and wherein
the spring has a degressive characteristic such that a graph of a force required to move the stem from the first position to the second position versus a deflection of the spring while moving from the first position to the second position is a nonlinear curve with a positive slope that decreases when moving from the first to the second position.

2. The actuator according to claim 1, wherein a force required to maintain the stem halfway between the first position and the second position is more than one-half a force required to maintain the stem in the second position.

3. The actuator according to claim 1, wherein a slope of the nonlinear curve at any point between the first position and a halfway point halfway to the second position is greater than the slope of the nonlinear curve at any point from the halfway point to the second position.

4. The actuator according to claim 1, wherein the spring encircles the stem.

5. The actuator according to claim 1, wherein the spring comprises:
an array of circular wavy springs stacked on each other, each of the wavy springs being split and having undulations defining crests and valleys.

6. The actuator according claim 5; wherein:
selected ones of the wavy springs are mounted with the valleys of one of the wavy springs nesting in the valleys of an adjacent one of the wavy springs; and
selected adjacent ones of the wavy springs are mounted with the valleys of one of the wavy springs abutting the crests of an adjacent one of the wavy springs.

7. The actuator according to claim 1, wherein the spring comprises an array of Belleville springs.

8. The actuator according to claim 1, wherein:
selected adjacent ones of the Belleville springs are nested within one another; and
selected adjacent ones of the Belleville springs are mounted opposed to each other.

9. The actuator according to claim 1, wherein the spring comprises:
a coil spring array; and wherein
the coil spring array has a varying outer diameter between the ends.

10. The actuator according to claim 9, wherein at least a portion of the coil spring array is barrel shaped, having a progressively increasing diameter from one of the ends to a central section and a decreasing diameter from the central section toward the other of the ends.

11. The actuator according to claim 9, wherein at east a portion of the coil spring array is in the shape of an hourglass, having a diameter that progressively decreases from one of the ends to a central section and an increasing diameter from the central section toward the other of the ends.

12. The actuator according to claim 1, further comprising:
a power source in engagement with the stem that when energized, causes the stern to move from the first position to the second position direction; and
wherein when the power source is de-energized, the spring has sufficient capacity to move the stem and the gate from the second position to the first position.

13. A gate valve, comprising:
a body having a flow passage intersected by a gate cavity;
a gate located in the gate cavity;
a housing secured to the body perpendicular to the flow passage;
a stem extending through the housing and coupled to the gate;
a hydraulically actuated piston cooperatively engaged with the stem for moving the stem and the gate from a closed to an open position;
the gate having a selected distance ratio determined by a distance from the closed position to a selected pinch point divided by a total distance from the closed position to the open position;
a spring encircling the stem within the housing, the spring having a fixed end fixed within the housing and a movable end cooperatively engaged with the stern for movement therewith, such that moving the stem in an opening direction compresses an axial length of the spring, and the axial length of the spring increases when the stem moves in a closing direction; and wherein
the spring has a characteristic such that a force ratio determined by an amount of force required to hold the gate at the selected pinch point divided by a force required to hold the gate at the closed position is greater than the distance ratio.

14. The actuator according to claim 13, wherein the spring comprises:
an array of circular wavy springs stacked on each other, each of the wavy springs being split and having undulations defining crests and valleys; wherein
selected ones of the wavy springs are mounted with the valleys of one of the wavy springs nesting in the valleys of an adjacent one of the wavy springs; and
selected adjacent ones of the wavy springs are mounted with the valleys of one of the wavy springs abutting the crests of an adjacent one of the wavy springs.

15. The actuator according to claim 13, Wherein the spring comprises:
an array of Belleville springs; wherein
selected adjacent ones of the Belleville springs are nested within one another; and
selected adjacent ones of the Belleville springs are mounted opposed to each other.

16. The actuator according to claim 13, wherein the spring comprises:
a coil spring array; wherein
the coil spring array has a varying outer diameter between the ends.

17. A method of allowing arid blocking flow through a conduit, comprising:
(a) coupling a stem to a gate valve having a gate located within a cavity in a body, the body having a flow passage transverse to the cavity, and securing the body within the conduit with the flow passage aligned with the conduit;
(b) providing a spring having a degressive characteristic such that a graph of a force required to contract the spring versus a deflection of the spring is a nonlinear curve with a positive slope that decreases when moving from an extended to a contracted position;
(c) mounting one end of the spring to the stem and securing an opposite end against movement with the stem;
(d) with a power source, moving the stem along an axis of the stem to place and hold the gate in an open position, which causes the spring to contract; then
(e) to move the gate to a dosed position, allowing the coil spring to extend, which moves the gate to the closed position due to a force of the spring.

18. The method according to claim 17, further comprising:
after step (d) and before step (e) placing a line within the conduit; and wherein
step (e) comprises with the force provided by the spring, severing the line between a portion of the gate and a portion of the body.

19. The method according to claim 18, wherein:
step (a) comprises:
measuring a pinch point distance from the closed position of the gate to a selected pinch point;
measuring a total distance the gate travels from the open position to the closed position;
dividing the pinch point distance by the total distance to determine a distance ratio; and
step (b) comprises:
measuring an amount of pinch point force required to hold the gate at the selected pinch point;
measuring an amount of open position force required to hold the gate at the open position;
dividing the pinch point force by the open position force to determine a force ratio; and
selecting the spring such that the force ratio is greater than the distance ratio.

20. The method according to claim 19, wherein the pinch point is selected as a point where the line is initially contacted by both said portion of the gate and said portion of the body.
